(19) United States
(12) Patent Application Publication
(10) Pub. No.: US 2025/0208154 A1
(43) Pub. Date: Jun. 26, 2025

(54) CONFIGURING AND CONTROLLING AUTOSAMPLER

(71) Applicant: Wyatt Technology, LLC, Goleta, CA (US)

(72) Inventors: Cha Lee, Sacramento, CA (US); Sophia Kendrick, Goleta, CA (US)

(21) Appl. No.: 18/990,338

(22) Filed: Dec. 20, 2024

Related U.S. Application Data
(60) Provisional application No. 63/613,298, filed on Dec. 21, 2023.

(51) Int. Cl. G01N 35/00; G01N 30/02; G01N 30/24

(52) U.S. Cl. CPC G01N 35/00722; G01N 30/24; G01N 2030/027; G01N 2035/0091

(57) ABSTRACT

A method for sample analysis comprises loading a plurality of samples into a plurality of sample storage vessels of a liquid chromatography instrument; receiving a plurality of parameters corresponding to the plurality of samples, the sample storage vessels holding samples of the plurality of samples having different parameters; dynamically displaying results from a measurement operation by an electrophoretic light scattering measurement instrument of the samples having the different parameters; and contemporaneously performing a combination of sample collection operations, sample injection operations, and sample storage unit washing operations.

### PRIORITY

This application claims priority to U.S. provisional patent application No. 63/613,298 filed Dec. 21, 2023, and titled “Configuring and Controlling Autosampler,” the entirety of which is incorporated by reference herein.

### FIELD

The present invention relates generally to an experiment design display layout for a fully automated electrophoretic light scattering analysis.

### BACKGROUND

Light scattering instruments are used to perform quantitation of molecular and nanoparticle properties for samples dissolved or suspended in solution. In doing so, these instruments may be used in a standalone (batch) mode or coupled to liquid handling or chromatographic systems. In environments such as laboratories where a large number of measurements are required, samples may be arranged in an array of vials or tubes of a tray or wells of a microplate for retrieval by a robotic autosampler, which can automatically load the samples into the instrument with accuracy and reproducibility. The instrument includes computer software to control the measurements of the samples. A user interface may execute a script for entering parameters for one vial at a time or applying the same parameters to a tray of samples.

It is desirable for an analytical instrument having an improved automation workflow in an environment providing a large number of sample measurements by facilitating the display of experiment designs in a manner that reduces the time it takes to populate the instrument with information for performing the sample measurements and for reducing time-consuming steps regarding collection, injection, washing, and measurement operations.

### SUMMARY

In one embodiment, a method for sample analysis comprises loading a plurality of samples into a plurality of sample storage vessels of a liquid chromatography instrument; receiving a plurality of parameters corresponding to the plurality of samples, the sample storage vessels holding samples of the plurality of samples having different parameters; dynamically displaying results from a measurement operation by an electrophoretic light scattering measurement instrument of the samples having the different parameters; and contemporaneously performing a combination of sample collection operations, sample injection operations, and sample storage unit washing operations.

In another embodiment, an autosampler for an electrophoretic mobility analysis system, comprises a plurality of sample storage vessels; a valve system comprising: a first fluidic port in communication with the sample storage vessels; and a second fluidic port that outputs a plurality of samples to a measurement apparatus. The autosampler further comprising an injection block in fluidic communication with a wash component, the injection block and the wash component in communication with a second fluidic port and a third fluidic port, respectively, of the valve system; and a special-purpose computer system that stores and executes program code to: receive a plurality of parameters corresponding to the plurality of samples, the sample storage vessels holding samples of the plurality of samples having different parameters; dynamically display results from a measurement operation by the measurement apparatus of the samples having the different parameters; and contemporaneously performing a combination of sample collection operations, sample injection operations, and sample storage unit washing operations performed by the valve system, the injection block, and the wash component.

In another embodiment, a computer implemented method comprising: displaying, by a computer system, on a display an experiment type page comprising experiment type icons; in response to receiving a selection command corresponding to one of the experiment type icons, displaying a vial selection page, comprising at least one selection vials receptacle graphic corresponding to a vial receptacle in an autosampler, wherein the selection vials receptacle graphic comprises selection vial graphics corresponding to vials in the vial receptacle, and an edit template icon; and further displaying a pump-sampler properties graphic corresponding to properties of a pump and properties of a sampler, wherein the pump-sampler graphic comprises pump-sampler entry box graphics corresponding to the pump-sampler properties and a replicates graphic corresponding to replicate operations for the sampler, wherein the replicates graphic comprises replicates entry box graphics corresponding to the replicate operations.

In another embodiment, an apparatus, system, and method comprise displaying an experiment type page, which comprises experiment type icons; in response to receiving a selection command corresponding to one of the experiment type icons, and displaying a vial selection page comprising at least one selection vials receptacle graphic corresponding to a vial receptacle in an autosampler. The selection vials receptacle graphic comprises selection vial graphics corresponding to vials in the vial receptacle and an edit template icon, and further comprises a pump-sampler properties graphic corresponding to properties of a pump and properties of a sampler (pump-sampler properties). The pump-sampler graphic comprises pump-sampler entry box graphics corresponding to the pump-sampler properties, and a replicates graphic corresponding to replicate operations for the sampler. The replicates graphic comprises replicates entry box graphics corresponding to the replicate operations. In response to receiving a selection vial selection command (click/drag) corresponding to one of the selection vial graphics, changing a color of the selected selection vial graphic to indicate that a corresponding vial has been selected to be measured. In response to receiving an edit template command (click), displaying an edit template page comprising at least one edit vials receptacle graphic, i.e., a tray graphic) corresponding to a vial receptacle in an autosampler. The edit vials receptacle graphic comprises edit vial graphics corresponding to vials in the vial receptacle, and a property icon. In response to receiving a property icon selection command, displaying a list of sample properties. In response to receiving a sample property selection command corresponding to one of the sample properties and in response to receiving an edit vial selection command (click) corresponding to one of the edit vial graphics, executing a series of logical operations allowing for inputting sample property values for the selected vial. In response to receiving a pump-sampler properties selection command corresponding to one of the pump-sampler entry box graphics, executing a series of logical operations allowing for inputting a value corresponding to the selected pump-sampler entry box graphic; and in response to receiving a replicates selection command corresponding to one of the replicates entry box graphics, executing a series of logical operations allowing for inputting a value corresponding to the selected replicates entry box graphic (number of scans, measurements per injection, do wash measurements).

In some embodiments, the apparatus, system, and method comprises displaying an experiments parameters page corresponding to parameters for measuring properties of the sample (what to measure, how to measure) (at least specify DLS measurements-parameters, ELS measurements-parameters, temperature parameters) for an experiment; and in response to receiving a save command, saving the inputted information; and in response to receiving a play command (play button), running the experiment on an electrophoretic light scattering measurement instrument.

### BRIEF DESCRIPTION OF THE DRAWINGS

The above and further advantages of this invention may be better understood by referring to the following description in conjunction with the accompanying drawings, in which like numerals indicate like structural elements and features in the various figures. For clarity, not every element may be labeled in every figure. The drawings are not necessarily to scale, emphasis instead being placed upon illustrating the principles of the invention.

FIG. 1 is a block diagram of a liquid chromatography system in which embodiments of the present inventive concept can be practiced.

FIG. 2 is a functional diagram of an autosampler in which embodiments of the present inventive concept can be practiced.

FIG. 3 is a flow diagram of a method for managing an autosampler and downstream detector, in accordance with some embodiments.

FIG. 4 is a screenshot of a user interface, in accordance with some embodiments.

FIGS. 5A-5E are screenshots of a user interface for performing a workflow, in accordance with some embodiments.

FIG. 6 is a screenshot of a user interface, in accordance with some embodiments.

FIG. 7 is a view of a gradient table, in accordance with some embodiments.

FIG. 8 is a screenshot of a user interface for entering data for a binary solvent manager, in accordance with some embodiments.

### DESCRIPTION

Reference in the specification to an embodiment or example means that a particular feature, structure or characteristic described in connection with the embodiment or example is included in at least one embodiment or example of the teaching. References to a particular embodiment or example within the specification do not necessarily all refer to the same embodiment or example.

The present teaching will now be described in detail with reference to exemplary embodiments or examples thereof as shown in the accompanying drawings. While the present teaching is described in conjunction with various embodiments and examples, it is not intended that the present teaching be limited to such embodiments and examples. On the contrary, the present teaching encompasses various alternatives, modifications, and equivalents, as will be appreciated by those of skill in the art. Moreover, features illustrated or described for one embodiment or example may be combined with features for one or more other embodiments or examples. Those of ordinary skill having access to the teaching herein will recognize additional implementations, modifications, and embodiments, as well as other fields of use, which are within the scope of the present disclosure as described herein.

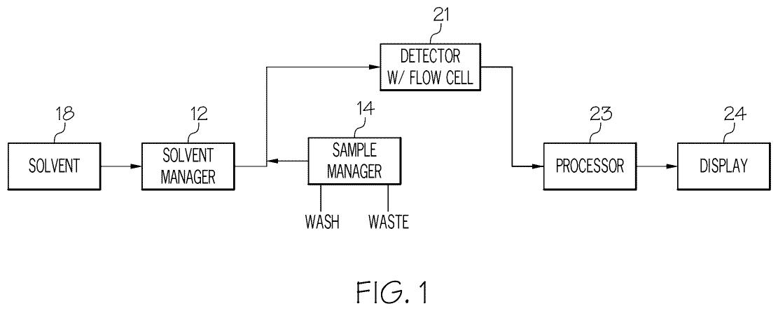

FIG. 1 is a block diagram of a liquid chromatography system 10 in which embodiments of the present inventive concept can be practiced.

In some embodiments, the liquid chromatography system 10 may include a solvent delivery system including a solvent manager 12 in fluidic communication with a sample manager 14 through tubing 16. The solvent manager 12 may include pumps (not shown) in fluidic communication with solvent reservoirs 18 from which the pumps draw solvents through tubing and deliver a mobile phase, or eluent, including a solvent composition to the sample manager 14. An example implementation of a solvent manager 12 is the Arc HPLC Binary Solvent Manager (BSM). Another example is a Quaternary Solvent Manager (QSM), each manufactured by Waters Corp. of Milford, MA. An example implementation of a liquid chromatography system is the Waters Arc HPLC system, manufactured by Waters Corp. of Milford, MA.

At least one sample is transferred from the sample manager 14 into the mobile phase and carried by the mobile phase to a downstream detector 21 by a high pressure pump (not shown).

The detector 21 is constructed and arranged to quantify properties of the sample delivered by the pump and autosampler. In some embodiments, the detector 21 is part of a light scattering instrument, for example, a ZetaStar dynamic light scattering (DLS) and electrophoretic light scattering (ELS) instrument manufactured by Waters Corp. of Milford, MA.

As described below, in some embodiments, the display 24 can provide an improved automation workflow when the system 10 performs a large number of sample measurements by facilitating the display of experiment designs in a manner that reduces the time it takes to populate the light scattering instrument 12 with information for performing the sample measurements and for reducing time-consuming steps regarding collection, injection, washing, and measurement operations. In doing so, the display 24 may be part of one or more computer processors that communicate with the solvent manager 14, the sample manager 14, and/or the detector 21.

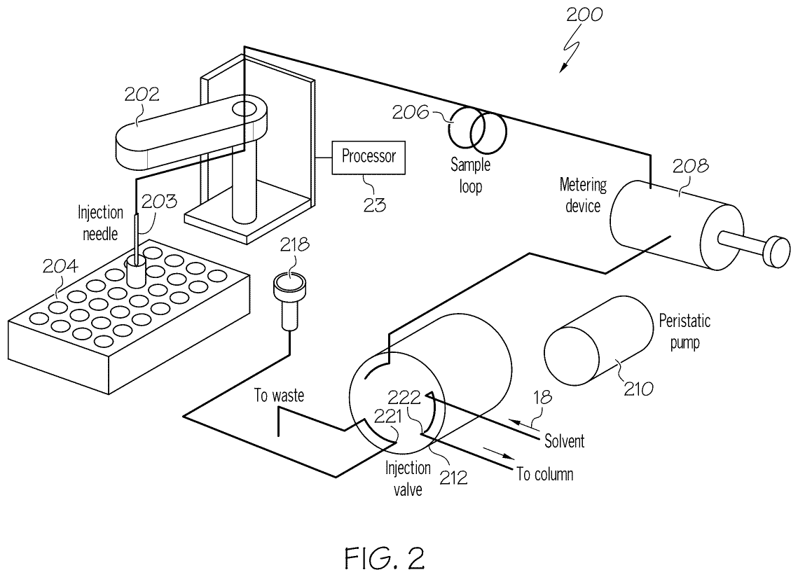

FIG. 2 is a functional diagram of an autosampler 200, in which embodiments of the present inventive concept can be practiced. In some embodiments, the autosampler 200 may be part of or include elements of the sample manager 14 of FIG. 1. The movements of the autosampler components during the sampling sequence are monitored continuously by the autosampler processor 23 and display 24.

The autosampler 200 is constructed and arranged to inject samples from various vials, for example, in a well plate 204, to a sample line 206 and relies on the pump to “flow” or push the sample to the downstream detector, or measurement apparatus. As shown, the autosampler 200 may include a multi-axis robot 202 that positions a sampling arm on a well plate 204. The processor 23 can be used to position the sampling arm over the programmed sample position, and draw a predetermined programmed sample volume using the metering device 208 into the sampling needle 203. The sampling arm then moves to the injection position where the sample is flushed onto detector 21. The flow path including the metering device 208 is flushed by the mobile phase after injection for minimum internal carry-over. The injection valve unit 212 can be driven by a stepper motor or the like so that during a sampling sequence, the valve unit 212 connects flow from the pump to detector 21. During injection and analysis, the valve unit 212 under control by the processor 23 and display 24 can provide a source of solvent 18 from a pump and direct the flow through the autosampler 200 which ensures that all of the sample is injected into the detector 21. The autosampler 200 includes a needle wash peristatic pump 210 or the like that may also be configured to perform wash operations, for example, to clean the sample line 206 after a sample has been injected. This is necessary because particulates from previous samples can remain in the sample line and contaminate the next injection.

Conventional event scheduling operations to perform a wash was to perform a second “injection” and to inject from a vial that only contained buffer/solvent. This is problematic for multiple reasons. First, one has to use at least half of the vials for “washing” so the maximum number of samples that can be analyzed at once is significantly reduced. Second, performing separate “wash injections” significantly increases the total experiment time due to the processes required to perform an injection. As described here, embodiments of the present inventive concept address and overcome these conventional limitations. For example, wash operations can be performed quickly and efficiently by combining inject and wash operations with respect to each sample vial, i.e., wash cycle as part of an injection, using a single user interface and programming technique, which improves end-to-end collection time.

Referring again to FIG. 2, the metering device 208 controls the amount of sample drawn by the injection needle 203 from the vials in the well plate 204. The injection valve 212 determines how the tubing is directed to waste or to the detector 21, depending whether the multi-port valve 212 is in an inject position, load position, or other position described herein. The injection needle 203 is plunged into one of the vials for receiving the sample involving vacuum, pressure, and so on.

At the start of an injection operation, the multi-port injection valve 212 can be set to a port arrangement where the fluid, e.g., solvent 18, from the pump is output directly to the detector 21. It is then drawn into the sample loop 206 by the metering device 208 and stays there. Then a hinge along the injection needle 203 moves to a port 218 coupled to one of the ports of the injection valve 212.

During an injection operation, the injection valve is switched to a port arrangement where the sample at port 218 is output from the injection needle 203 to the port 218 and via a fluid path (not shown) between ports 221, 222 to the detector 21. Here, the buffer from the pump goes through the sample loop 206 and pushes the sample out. Once the sample has been fully injected and on its way to the detector 21, the valve 212 will then switch back to the state shown in FIG. 2.

The foregoing steps using conventional autosampler management operations can take a significant amount of time depending on various parameters and specific hardware. This can take upwards of 5 to 10 minutes before the injection even occurs. In cases where a sample process and a wash process are performed, the collection time can be double that of a single collection process.

In brief overview, embodiments of the present inventive concept include a special-purpose computer display and experiment method using the liquid chromatography system 10 of FIG. 1 including the autosampler 200 of FIG. 2 to ensure a fast and accurate execution of sample experiments, thereby increasing laboratory efficiency and productivity with dozens or hundreds, or more, unattended measurements. The embodiments include a user interface including graphics arranged to allow users to display a plurality of vials from which to collect samples and to specify sample parameters related to any workflow parameter from any tube, vial, well, or the like in a tray, microplate, or the like identified for an experiment, for example, on an individual, or vial-by-vial basis.

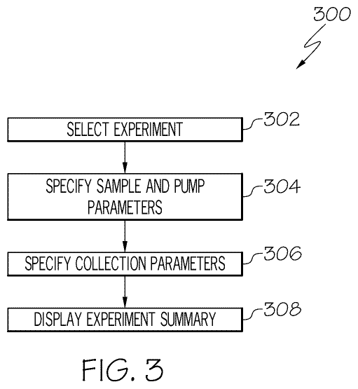

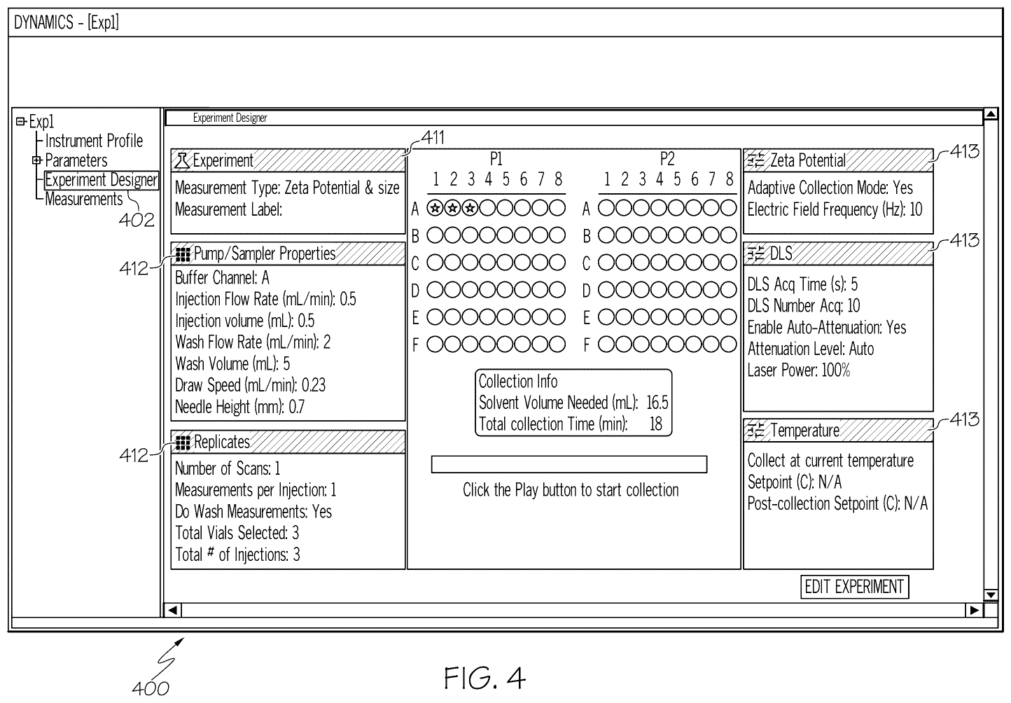

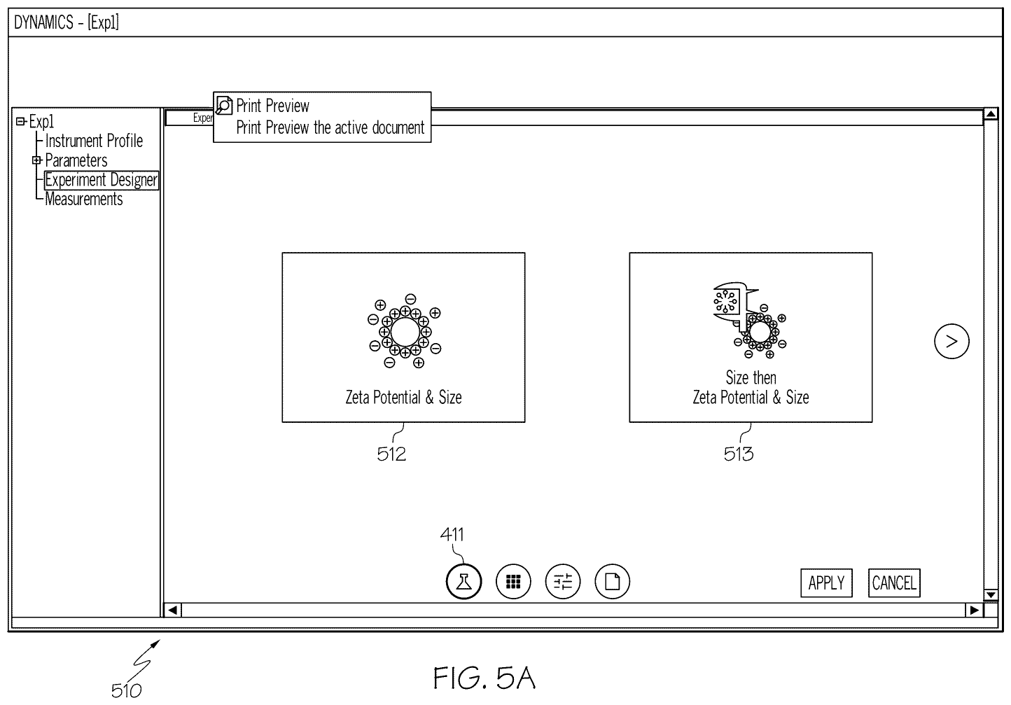

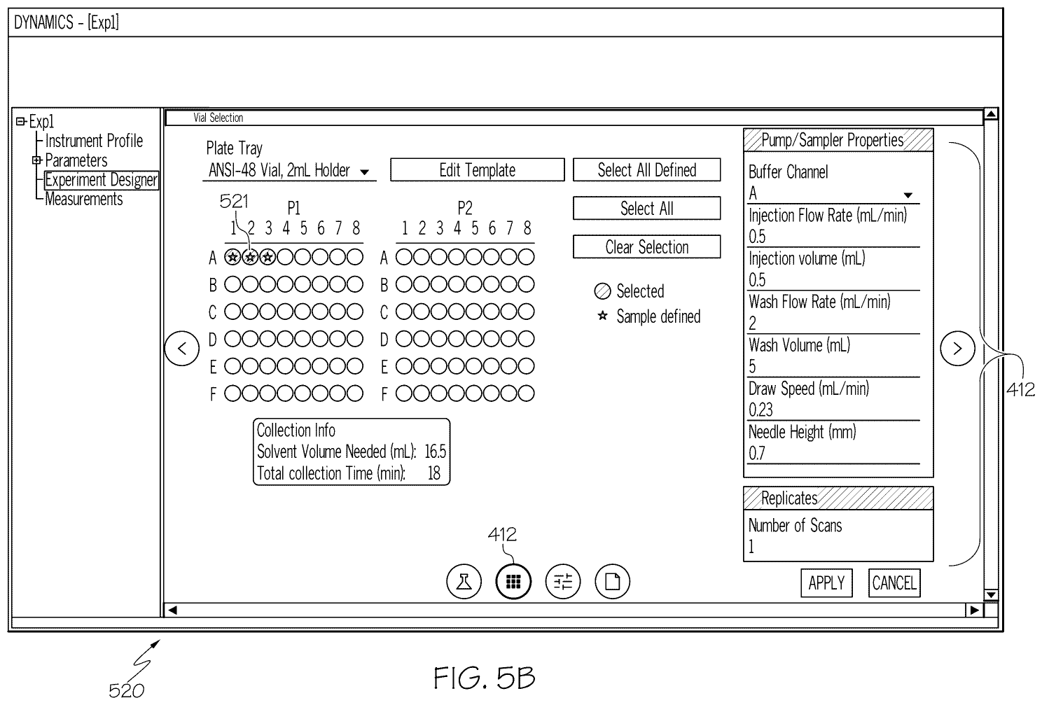

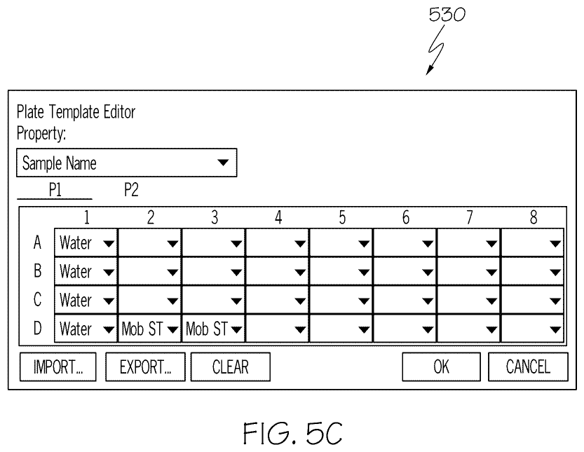

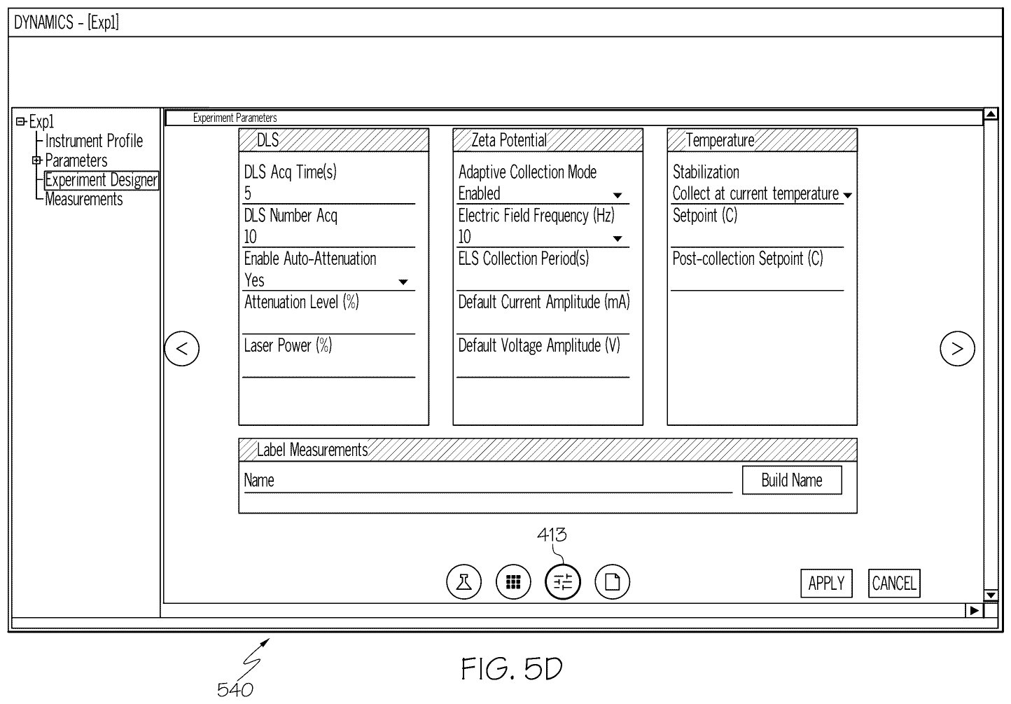

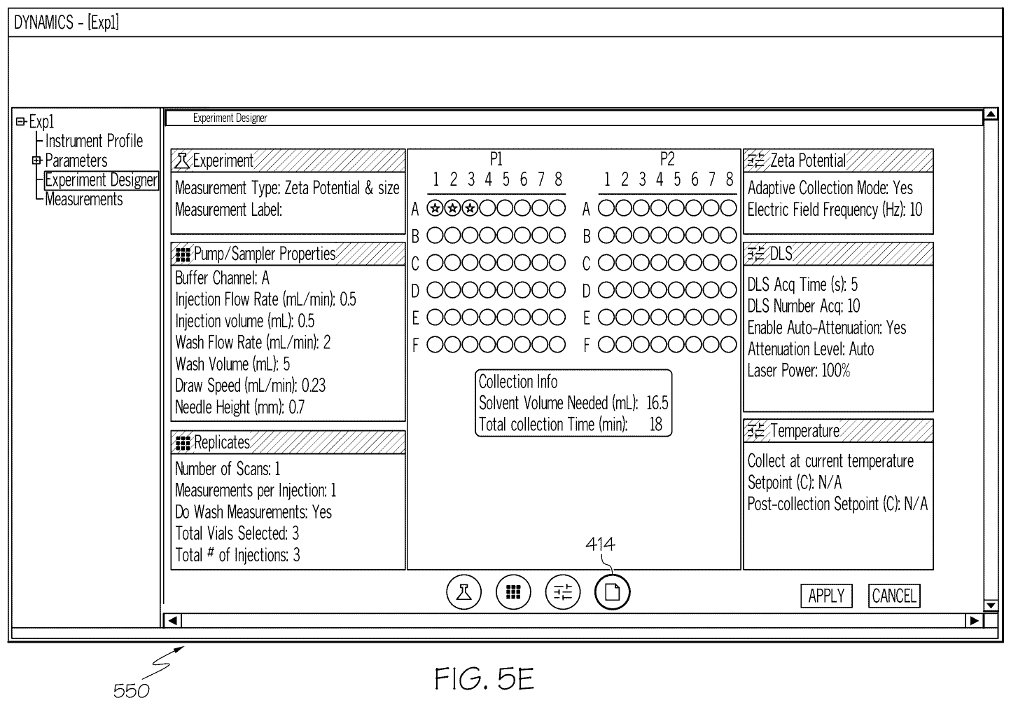

FIG. 3 is a flow diagram of a method 300 for managing an autosampler, in accordance with some embodiments. In describing the method 300, reference is made to the liquid chromatography system 10 of FIG. 1. Reference is also made to the user interface screenshots illustrated in FIGS. 4-5E.

FIG. 4, shown is a screenshot of a user interface 400, which allows a user such as an experiment designer, an ability to automate the collection of ELS and DLS data using a liquid chromatography system, for example, shown in FIG. 1. The experiment designer interface 400 is preferably used in an automation workflow that includes injections into a flow cell, for example, during light scattering measurements. In some embodiments, the experiment designer interface 400 provides four different function screens, for example, constructed and arranged as web pages or the like. A function screen can be displayed for experiment type, vial selection, experiment parameters, and summary, by selecting corresponding buttons 411-414 shown in FIGS. 5A-5E.

Conventional interfaces allow users to programmatically create an “event schedule” (script) that contained script like commands to specify sample injection vial locations, sample injection parameters, wash vial locations, wash parameters, and ELS/DLS collection parameters. From an ease-of-use perspective, this is prone to human error and was difficult to use. The user interface 400 has an experiment designer mode 402 that improves the ease-of-use by introducing a workflow-like interface, which includes a graphical interface to specify vials and sample parameters.

Referring again to FIG. 3, at step 302, the user interface 400 permits a user to select an experiment type by displaying a first webpage or the like, for example, see the screenshot of the user interface 510 shown in FIG. 5A. Here, the user interface 510 displays two experiment types.” The first type is a “Zeta Potential & Size” experiment type 512, where simultaneous ELS and DLS data are collected simultaneously to provide measurements of zeta potential and size. This may be displayed in a field 411 in FIG. 4. The second type is a “Size then Zeta Potential & Size” experiment type 513, where a DLS measurement is performed and then ELS & DLS data are collected simultaneously in the flow cell. This option allows you to compare data collected with and without an applied electric field to determine if the applied field changes the sample in some way.

At step 304, the user interface 400 permits a user to specify sample and pump parameters by displaying a second webpage or the like, for example, see the screenshot of the user interface 520 shown in FIG. 5A. The user specifies vial locations 521 by using the mouse to click on each “circle” (vial) or click and drag the mouse to select a set of vials. The user can specify the autosampler and pump properties 412 shown in FIG. 4 via a few parameters on the right, for example, injection volume, flow rate, vial, number of injections, etc. A button can be selected for presenting the user interface 520. The button can correspond to the autosampler and pump properties 412 shown in FIG. 4.

As shown in FIGS. 4-5E, pump/sampler properties 412 can include but not be limited to buffer channel, injection flow rate, injection volume, wash flow rate, wash volume, draw speed, and needle height. Some or all of these properties can be submitted and used in the operation described in FIGS. 5D and 5E. The buffer channel property is the solvent reservoir used by the pump for washing with buffer. The injection flow rate (mL/min) parameter is the flow rate used for injecting sample. The injection volume (mL) parameter is the volume of sample injected into the flow cell. The wash flow rate (mL/min) parameter is the flow rate used for washing with buffer between sample injections. The wash volume (mL) parameter is the volume of buffer/solvent used to wash between sample injections. The draw speed (mL/min) parameter is the draw speed used to pull sample from the vial using the autosampler needle. The needle height (mm): parameter is the height of the autosampler needle when drawing sample from the vial.

The sample properties either illustrated in the screenshots herein, or not shown but described with respect to some embodiments may include a combination of properties presented in a drop-down list and properties entered by way of a numeral entry field. Properties via drop-down list may include but are not limited to Sample Name, Solvent, Cuvette, Mw-R Model, Zeta Potential Model, Conformation Model for SLS, Viscosity Calculation, Particle Concentration Calculation, Particle Material, and Particle Shape. Properties entered via a numeral entry field may include but not be limited to Default Concentration (mg/mL), dn/dc (mL/g), A2 (mol mL/g²), Ionic Strength, Internal Standard Rh (nm), Internal Standard Rh Range Minimum (nm), Internal Standard Rh Range Maximum (nm), Core Real Refractive Index @785 nm, and Core Imaginary Refractive Index @785 nm.

In some embodiments, properties 412 may include replicate properties, include number of scans, measurements per injection, and wash measurements. The number of scans value that can be entered is the number of times to scan the entire set of selected vials. All selected vials are measured before repeating the scan. The measurements per injection property is the number of measurements performed for each selected vial. The “Do Wash Measurements” field, if set to Yes, allows data to be collected after washing the flow cell with solvent/buffer and before the next sample injection. This data can be used to determine the cleanliness of the flow cell and to ensure sufficient washing has been performed. If set to No, measurements are only conducted on sample injections. Additional or different configuration options may be available, but are not shown.

The user can also specify sample parameters (needed for real-time results) by using the plate template editor 530, displayed as a third webpage or the like as shown in FIG. 5C. This editor allows the user to specify unique sample parameters (available in the “Property” dropdown menu) for each vial. Here, information for the vials that will be injected can be edited, for example, information such as sample name, solvent, zeta potential model, ionic strength, and so on.

At step 306, the user interface 400 permits a user to specify sample and pump parameters by displaying a fourth webpage or the like, for example, see the screenshot of the user interface 540 shown in FIG. 5D, where collection parameters can be specified. A button 413 corresponding to the experiment parameters page can be selected for presenting the user interface 540. The button 413 can correspond to the zeta potential, DLS, and temperature control properties 413 shown in FIG. 4. Here, the user can easily specify how to collect DLS and ELS data, as well as temperature controls and how to name the collected data (measurements). As shown in FIGS. 4-5E, experiment parameters 413 can be used for selecting parameters to use for experiments, for example, measurement parameters such as DLS acquisition time, etc.

At step 308, a summary of the experiment can be displayed, for example, see the screenshot of the user interface 550 shown in FIG. 5E. Here, the user is shown a summary of their experiment with helpful text to ensure they have enough solvent/buffer and time to collect their data. A button 414 can be selected for presenting the user interface 550. The button 414 can present the experiment summary data shown in the user interface 550. By selecting the summary button 414 information about an experiment can be displayed. The current selections can be displayed at the experiment designer node of the user interface 400.

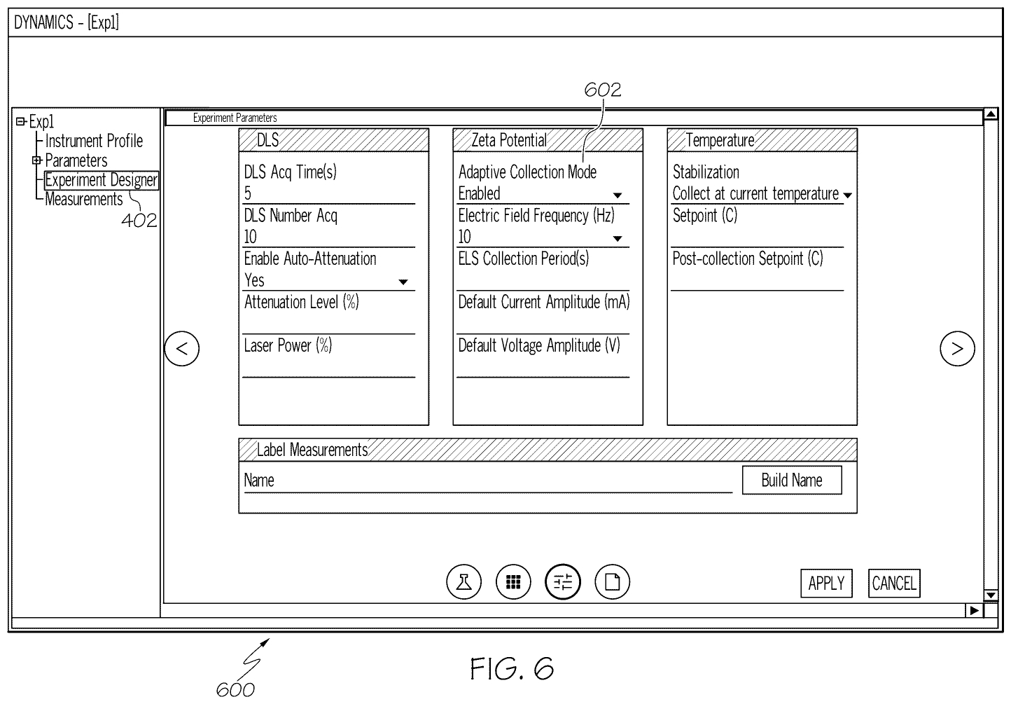

ELS data collection can be challenging with very different sample compositions. In an ELS measurement, applying an electric field can change the sample or degrade it if the field strength is too high for the sample. In some embodiments, as shown in FIG. 6, a user interface 600 has an adaptive collection mode 602 that includes a feature that automatically determines a safe electric field strength to apply to a sample and the optimal collection time to collect ELS data without changing the sample. By default, this can be enabled in the experiment designer mode 402 and is required when attempting to measure very different samples.

Most autosamplers also have the concept of “washes”, which refers to the need to clean the sample line after a sample has been injected. This is necessary because particulates from previous samples can remain in the sample line and contaminate the next injection.

In some embodiments, referring to the event schedule process above, a wash operation may be performed by performing a second “injection” and to inject from a vial that only contains buffer or solvent. This is problematic for multiple reasons. In particular, one has to use at least half of the vials for the wash operation which reduces the number of samples that may be run.

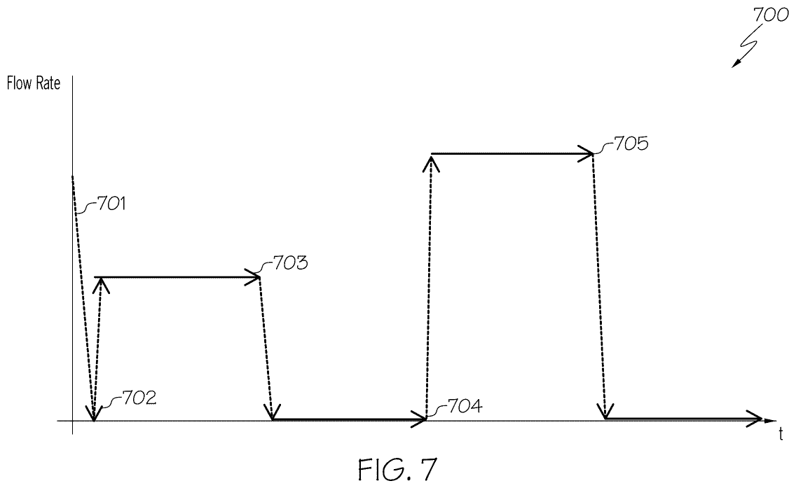

Embodiments of the experiment designer features overcome these disadvantages of conventional wash operations by removing the need for wash injections by applying a gradient table feature of the HPLC pump. Here, the autosampler processor 23 can reprogram an injection operation so that instead of simply flowing just the amount of solvent needed to deliver the sample and stopping, the processor 23 programmatically introduces a very long “injection” and combines sample injection with data collection and washing, which provides improvements with respect to the above. With regard to the user interface 400, a user is only required to enter the amount of wash volume and how fast they want to wash. In response, the system generates a gradient table 700, for example, shown in FIG. 7. In some embodiments, the experiment designer features obviate the need for wash injections by applying a gradient table feature of a HPLC pump.

Each line in the gradient table 700 allows the user to specify what happens at a specific time during an injection. The processor 23 can perform calculations so that the correct flow rate is performed during each step of injection.

The first line 701 of the gradient table 700 establishes the initial conditions. As shown in the user interface 800, gradient values 802 may include setting a buffer channel percentage, for example, 100% of channel A and 0% channel B.

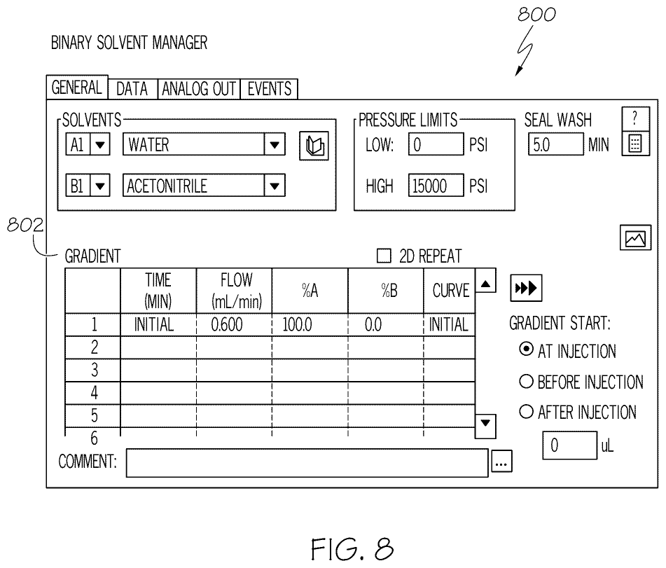

The second line 702 refers to the start of the injection flow operation, where the sample is injected. For example, in the user interface, the time of the start of the “injection flow” during which the sample is injected can be set to 0.1 min, or time T2 at a flow rate of 0.60 mL/min (see FIG. 8).

The third line 703 indicates where the flow can be stopped for collecting data. The user interface permits a time value to be calculated, for example, by multiplying a time factor value (a fractional value from 0-1) and injection volume divided by injection flow rate+time T2, the calculated result referred to as time T3. In some examples, the flow rate can be set to a zero (0) value. The buffer channel percentage does not change.

The fourth line 704 indicates the start of a wash cycle. Here, the time can set to a value calculated according to “Collection Time”+time (T3), referred to as time (T4). The Collection Time is defined by how long it will take us to do perform measurements. This can be determined based on acquisition time and other parameters for DLS and Zeta Potential, or the like. The flow can be set to a wash flow rate, shown in FIG. 4, pump/sampler properties 412. The buffer channel percentage does not change.

The fifth line 705 indicates a stop of the wash operation so that data can again be collected. Here, the time can set to a value calculated according to “Wash Volume”/“Wash Flow Rate”+time (T4), or T5. Here, the flow is set to zero, and the buffer channel percentage does not change.

As described above, embodiments of the present inventive concept include a computer system that provides an experiment design display layout for a fully automated electrophoretic light scattering analysis using an autosampler or the like. Accordingly, the computer system is capable of being implemented to perform and/or performing any of the functionality/operations of the present invention.

Below follows an itemized list of statements describing embodiments in accordance with the inventive concepts:

A computer implemented method comprises displaying, by a computer system, on a display an experiment type page comprising experiment type icons; in response to receiving a selection command corresponding to one of the experiment type icons, displaying a vial selection page comprising: at least one selection vials receptacle graphic (i.e., tray graphic) corresponding to a vial receptacle in an autosampler (e.g., Waters Sample Manager), wherein the selection vials receptacle graphic comprises selection vial graphics corresponding to vials in the vial receptacle, and an edit template icon, a pump-sampler properties graphic corresponding to properties of a pump and properties of a sampler (pump-sampler properties), wherein the pump-sampler graphic comprises pump-sampler entry box graphics corresponding to the pump-sampler properties, and a replicates graphic corresponding to replicate operations for the sampler, wherein the replicates graphic comprises replicates entry box graphics corresponding to the replicate operations; in response to receiving a selection vial selection command (click/drag) corresponding to one of the selection vial graphics, changing a color of the selected selection vial graphic to indicate that a corresponding vial has been selected to be measured; in response to receiving an edit template command (click), displaying an edit template page comprising at least one edit vials receptacle graphic (i.e., tray graphic) corresponding to a vial receptacle in an autosampler (e.g., Waters Sample Manager), wherein the edit vials receptacle graphic comprises edit vial graphics corresponding to vials in the vial receptacle, and a property icon; in response to receiving a property icon selection command, displaying a list of sample properties; in response to receiving a sample property selection command corresponding to one of the sample properties and in response to receiving an edit vial selection command (click) corresponding to one of the edit vial graphics, executing a series of logical operations allowing for inputting sample property values for the selected vial (1 way-drop down list, 2nd way-data entry); in response to receiving a pump-sampler properties selection command corresponding to one of the pump-sampler entry box graphics, executing a series of logical operations allowing for inputting a value corresponding to the selected pump-sampler entry box graphic; and in response to receiving a replicates selection command corresponding to one of the replicates entry box graphics, executing a series of logical operations allowing for inputting a value corresponding to the selected replicates entry box graphic (number of scans, measurements per injection, do wash measurements); and displaying an experiments parameters page corresponding to parameters for measuring properties of the sample (what to measure, how to measure) (at least specify DLS measurements, ELS measurements-parameters, temperature parameters) for an experiment; and in response to receiving a save command, saving the inputted information; and in response to receiving a play command (play button), running the experiment on an electrophoretic light scattering measurement instrument.

In some embodiments, the experiment type icons are selected from a group consisting of (a) an icon corresponding to zeta potential and size, and (b) an icon corresponding to size then zeta potential and size. In some embodiments, the method further comprises displaying a label measurements graphic comprising a label measurement entry box graphic. In some embodiments, the method further comprises in response to receiving a label measurements graphic selection command, executing a series of logical operations allowing for inputting a label for each measurement in the experiment via the label measurement entry box graphic. In some embodiments, the method further comprises displaying a summary/collection page to display what is being collected, which vial is being collected. (real-time status/progress).

In some embodiments, computer system includes a computer system/server, which is operational with numerous other general purpose or special purpose computing system environments or configurations. Examples of well-known computing systems, environments, and/or configurations that may be suitable for use with computer system/server 812 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

The computer system/server may be described in the general context of computer system-executable instructions, such as program modules, being executed by a computer system. Generally, program modules may include routines, programs, objects, components, logic, and/or data structures that perform particular tasks or implement particular abstract data types. Computer system/server may be practiced in distributed cloud computing environments where tasks are performed by remote processing devices that are linked through a communications network. In a distributed cloud computing environment, program modules may be located in both local and remote computer system storage media including memory storage devices. The computer system/server may be in the form of a general-purpose computing device. The components of computer system/server may include, but are not limited to, one or more processors or processing units, a system memory, and a bus that couples various system components including system memory to processor. Computer system/server may also communicate with one or more external devices such as a keyboard, a pointing device, a display, one or more devices that enable a user to interact with computer system/server, and/or any devices (e.g., network card, modem, etc.) that enable computer system/server to communicate with one or more other computing devices. Such communication can occur via Input/Output (I/O) interfaces.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the invention has been shown and described with reference to specific embodiments, it should be understood by those skilled in the art that various changes in form and detail may be made therein without departing from the spirit and scope of the invention as recited in the accompanying claims. It is appreciated that certain features of the inventive concepts, which are, for clarity, described in the context of separate embodiments, may also be provided in combination in a single embodiment. Conversely, various features of the inventive concepts which are, for brevity, described in the context of a single embodiment may also be provided separately or in any suitable sub-combination.

1. A computer implemented method for sample analysis, comprising:
loading a plurality of samples into a plurality of sample storage vessels of a liquid chromatography instrument;
receiving a plurality of parameters corresponding to the plurality of samples, the sample storage vessels holding samples of the plurality of samples having different parameters;
dynamically displaying results from a measurement operation by an electrophoretic light scattering measurement instrument of the samples having the different parameters; and
contemporaneously performing a combination of sample collection operations, sample injection operations, and sample storage unit washing operations.

2. The method of claim 1, further comprising:
dynamically displaying the results for a fully automated electrophoretic light scattering analysis.

3. The method of claim 1, wherein contemporaneously performing the combination of sample collection operations, sample injection operations, and sample storage unit washing operations includes combining a sample injection operation of the sample injection operations with data collection and a washing operation of the sample storage unit washing operations.

4. The method of claim 1, further comprising:
establishing initial conditions of the plurality of samples;
initiating an injection flow operation; and
stopping the injection flow operation to collecting including at least some of the plurality of parameters.

5. The method of claim 4, further comprising:
initiating a wash cycle; and
stopping the wash cycle to collect data regarding the wash cycle.

6. The method of claim 1, wherein dynamically displaying the results comprises:
displaying at a computer display an experiment type page comprising experiment type icons; and
in response to receiving a selection command corresponding to one of the experiment type icons, displaying a vial selection page comprising: at least one selection vials receptacle graphic corresponding to a vial receptacle in an autosampler, wherein the selection vials receptacle graphic comprises selection vial graphics corresponding to vials in the vial receptacle, and an edit template icon.

7. The method of claim 1, wherein dynamically displaying the results comprises:
displaying at a computer display a pump-sampler properties graphic corresponding to properties of a pump and properties of a sampler, wherein the pump-sampler graphic comprises pump-sampler entry box graphics corresponding to the pump-sampler properties, and a replicates graphic corresponding to replicate operations for the sampler.

8. An autosampler for an electrophoretic mobility analysis system, comprising:
a plurality of sample storage vessels;
a valve system comprising:
a first fluidic port in communication with the sample storage vessels; and
a second fluidic port that outputs a plurality of samples to a measurement apparatus;
an injection block in fluidic communication with a wash component, the injection block and the wash component in communication with a second fluidic port and a third fluidic port, respectively, of the valve system; and
a special-purpose computer system that stores and executes program code to:
receive a plurality of parameters corresponding to the plurality of samples, the sample storage vessels holding samples of the plurality of samples having different parameters;
dynamically display results from a measurement operation by the measurement apparatus of the samples having the different parameters; and
contemporaneously performing a combination of sample collection operations, sample injection operations, and sample storage unit washing operations performed by the valve system, the injection block, and the wash component.

9. The autosampler of claim 8, wherein contemporaneously performing the combination of sample collection operations, sample injection operations, and sample storage unit washing operations includes combining a sample injection operation of the sample injection operations with data collection and a washing operation of the sample storage unit washing operations.

10. The autosampler of claim 8, wherein the special-purpose computer system stores and executes program code further comprising:
establishing initial conditions of the plurality of samples;
initiating an injection flow operation; and
stopping the injection flow operation to collecting including at least some of the plurality of parameters.

11. The autosampler of claim 10, wherein the special-purpose computer system stores and executes program code further comprising:
initiating a wash cycle; and
stopping the wash cycle to collect data regarding the wash cycle.

12. A computer implemented method comprising:
displaying, by a computer system, on a display an experiment type page comprising experiment type icons;
in response to receiving a selection command corresponding to one of the experiment type icons, displaying a vial selection page, comprising at least one selection vials receptacle graphic corresponding to a vial receptacle in an autosampler, wherein the selection vials receptacle graphic comprises selection vial graphics corresponding to vials in the vial receptacle, and an edit template icon;
further displaying a pump-sampler properties graphic corresponding to properties of a pump and properties of a sampler, wherein the pump-sampler graphic comprises pump-sampler entry box graphics corresponding to the pump-sampler properties and a replicates graphic corresponding to replicate operations for the sampler, wherein the replicates graphic comprises replicates entry box graphics corresponding to the replicate operations.

13. The method of claim 12, wherein:
in response to receiving a selection vial selection command corresponding to one of the selection vial graphics, changing a color of the selected selection vial graphic to indicate that a corresponding vial has been selected to be measured; and
in response to receiving an edit template command, displaying an edit template page comprising at least one edit vials receptacle graphic corresponding to a vial receptacle in an autosampler.

14. The method of claim 13, wherein:
the edit vials receptacle graphic comprises edit vial graphics corresponding to vials in the vial receptacle, and a property icon; in response to receiving a property icon selection command, displaying a list of sample properties;
in response to receiving a sample property selection command corresponding to one of the sample properties and in response to receiving an edit vial selection command corresponding to one of the edit vial graphics, executing a series of logical operations allowing for inputting sample property values for the selected vial; and
in response to receiving a pump-sampler properties selection command corresponding to one of the pump-sampler entry box graphics, executing a series of logical operations allowing for inputting a value corresponding to the selected pump-sampler entry box graphic; and
in response to receiving a replicates selection command corresponding to one of the replicates entry box graphics, executing a series of logical operations allowing for inputting a value corresponding to the selected replicates entry box graphic (number of scans, measurements per injection, do wash measurements).

15. The method of claim 12, further comprising:
displaying an experiments parameters page corresponding to parameters for measuring properties of the sample for an experiment.

16. The method of claim 15, wherein:
in response to receiving a save command, saving the inputted information; and
in response to receiving a play command, running the experiment on an electrophoretic light scattering measurement instrument.

17. The method of claim 12 wherein the experiment type icons are selected from a group consisting of (a) an icon corresponding to zeta potential and size, and (b) an icon corresponding to size then zeta potential and size.

18. The method of claim 12 comprising displaying a label measurements graphic comprising a label measurement entry box graphic.

19. The method of claim 18 comprising in response to receiving a label measurements graphic selection command, executing a series of logical operations allowing for inputting a label for each measurement in the experiment via the label measurement entry box graphic.

20. The method of claim 12 further comprising displaying a summary/collection page to display what is being collected, which vial is being collected.
